(19) United States
(12) Patent Application Publication
(10) Pub. No.: US 2002/0174056 A1
(43) Pub. Date: Nov. 21, 2002

(54) System and method for providing user-specific options trading data

(76) Inventors: Mark Sefein, Dallas, TX (US); Arthur Kenneth Selender, Dallas, TX (US)

Correspondence Address: Christopher J. Rourk, Akin, Gump, Strauss, Hauer & Feld, L.L.P., Suite 4100, 1700 Pacific Avenue, Dallas, TX, 75201-4675, US

(21) Appl. No.: 09/862,044

(22) Filed: May 21, 2001

(51) Int. Cl. G06F 17/60

(52) U.S. Cl. 705/37

(57) ABSTRACT

A system for providing options trading data is provided. The system includes an options data system storing options data, such as options that are presently available to be bought or sold in an options marketplace. The system also includes a user profile system that stores user profile data, such as data that indicates the user's aversion to risk. An options selection system connected to the user profile system and the options data system generates options trading data, such as by selecting options that are presently available based on the user's aversion to risk. In this manner, a user with limited options trading experience can be provided with options trade suggestions that match the user's risk preferences.

### DESCRIPTION OF THE RELATED ART

Options trading systems for trading options to buy and sell securities and securities indexes are known in the art. Such options trading systems allow users to select from available options, such as by displaying the option price (typically calculated under the Black-Scholes model), indicating the number of trades or outstanding positions that have been written on the options, and other relevant data. A user may then select an option, such as by selecting an underlying security or index, a strike price, and determining whether the user wants to hedge an existing position, such as by writing a covered call or purchasing a collar, purchase a pure option, such as by buying an uncovered call or uncovered put, or purchase any other options.

One significant drawback with such option systems is that no indication is made to the user of the appropriateness of selling or purchasing the option. For example, if the user writes an uncovered call, then that user could be at significant risk if the stock price increases significantly. Likewise, if the user writes a covered call that is significantly in the money, such as where the underlying stock price is $40 a share and the user writes a covered call at $20 a share, then the user might not be maximizing their potential return for the option. Due to the fear of these risks and the unfamiliarity with the advantages of options, many investors do not enter buy and sell options. Furthermore, inexperienced users that do choose to buy and sell options often incur losses that are greater than they were willing to incur because of misunderstandings of options trading principles and strategies.

### BRIEF SUMMARY OF THE INVENTION

In accordance with the present invention, a system and method for providing user-specific options trading data are provided that overcome known problems with providing options trading data.

In particular, a system and method for providing user-specific options trading data are disclosed that allow a user to enter data that can be used to classify the user's aversion to risk, and which then select options trading data, such as recommended options trades, that match the user's aversion to risk, trading objectives, and other user-specific criteria.

In accordance with an exemplary embodiment of the present invention, a system for providing options trading data is provided. The system includes an options data system storing options data, such as options that are presently available to be bought or sold in an options marketplace. The system also includes a user profile system that stores user profile data, such as data that indicates the user's aversion to risk. An options selection system connected to the user profile system and the options data system generates options trading data, such as by selecting options that are presently available based on the user's aversion to risk. In this manner, a user with limited options trading experience can be provided with options trade suggestions that match the user's risk preferences.

The present invention provides many important technical advantages. One important technical advantage of the present invention is a system for providing options trading data that selects from available options based on the user's aversion to risk and investment goals. The present invention thus eliminates options for the user that have an increased risk of loss if the user has a high risk aversion, and eliminates options for the user that have a lower return if the user has a low risk aversion.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for providing options trading data in accordance with an exemplary embodiment of the present invention;

FIG. 2 is a diagram of a system for providing user profile data in accordance with an exemplary embodiment of the present invention;

FIG. 3 is a diagram of a system for generating strategy data and options recommendation data in accordance with an exemplary embodiment of the present invention;

FIG. 4 is a flowchart of a method for providing strategy data and options recommendation data to a user in accordance with an exemplary embodiment of the present invention;

FIG. 5 is a flowchart of a method for receiving user profile data and a user's risk aversion data in accordance with an exemplary embodiment of the present invention;

FIG. 6 is a matrix for providing hedging strategy data in accordance with an exemplary embodiment of the present invention;

FIG. 7 is a matrix for providing pure options strategy data in accordance with an exemplary embodiment of the present invention; and

FIGS. 8A-8B are a flowchart of a method for providing options recommendation data in accordance with an exemplary embodiment of the present invention.

### DETAILED DESCRIPTION OF THE INVENTION

In the description that follows, like parts are marked throughout the specification and drawings at the same reference numerals, respectively. The drawing figures might not be to scale, and certain components can be shown in generalized or schematic form and identified by commercial designations in the interest of clarity and conciseness.

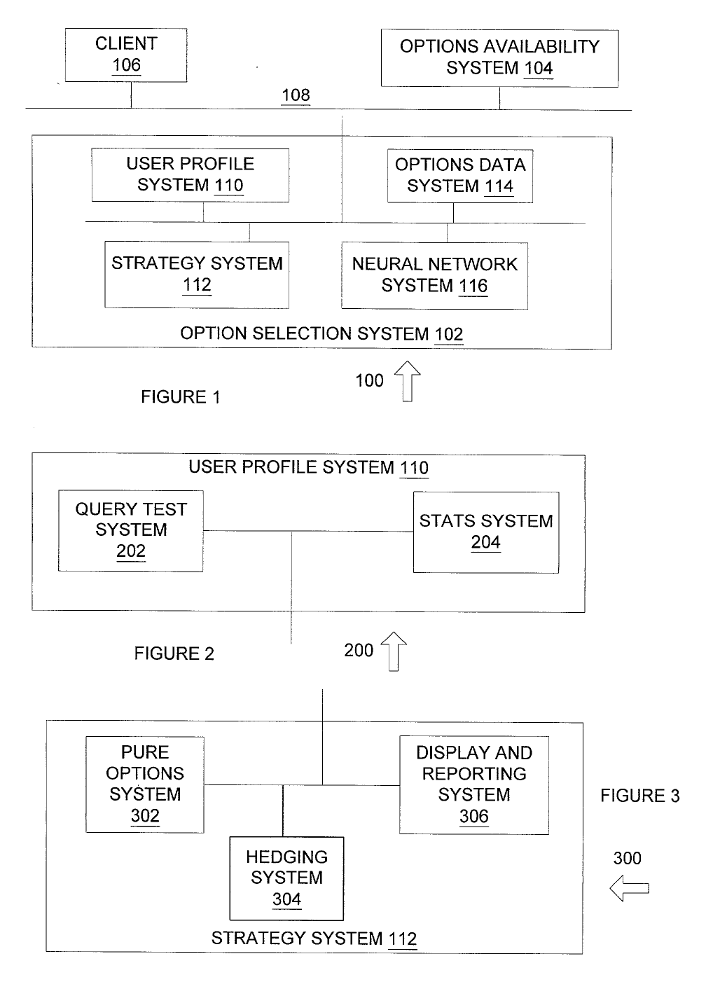

FIG. 1 is a diagram of a system 100 for providing options trading data in accordance with an exemplary embodiment of the present invention. System 100 allows a user with limited options trading experience to enter risk aversion data and option selection data, and that option selection data is used to select one or more potential options for the user to consider purchasing or selling that are consistent with the user's risk aversion data.

System 100 includes option selection system 102, which can be implemented in hardware, software, or a suitable combination of hardware and software, and which can be one or more software systems operating on a general purpose server platform. As used herein, a software system can include one or more objects, agents, threads, subroutines, separate software applications, two or more lines of code or other suitable software structures operating in two or more separate software applications, on two or more different processors, or other suitable software architectures. In one exemplary embodiment, a software system can include one or more lines of code or other suitable software structures operating in a general purpose software application, such as an operating system, and one or more lines of code or other suitable software structures operating in a specific purpose software application. In another exemplary embodiment, a software system can be one or more lines of hypertext markup language (HTML), extensible markup language (XML), or other suitable code that operates in conjunction with a web browser application, prompting a user to enter data or providing data to a user.

Option selection system 102 is coupled to options availability system 104 and client 106 by a communications medium 108. As used herein, the term “couple”, and its cognate terms such as “couples” and “coupled”, can include a physical connection (such as through one or more copper conductors), a virtual connection (such as one or more randomly assigned data memory locations of a data memory device), a logical connection (such as through one or more logical devices of a semiconducting circuit), a wireless connection, a hypertext transfer protocol (HTTP) connection, other suitable connections, or a suitable combination of such connections. In one exemplary embodiment, systems and components can be coupled to other systems and components through intervening systems and components, such as through an operating system of a general purpose server platform.

Communications medium 108 can be the Internet, a local area network, a wide area network, the public switched telephone network, a wireless network, fiber-optic network, other suitable communications media, or a suitable combination of such communications media.

In one exemplary embodiment, option selection system 102 receives option selection data and risk aversion data from client 106 and options market data from options availability system 104 and generates options recommendation data. The options recommendation data is a subset of the options availability data that matches the client's risk aversion data and option selection data received from client 106. If no options are available that match the risk aversion data, then option selection system 102 can notify the operator of client 106 of that condition.

Option selection system 102 includes user profile system 110, strategy system 112, options data system 114, and neural network system 116, each of which can be implemented in hardware, software, or a suitable combination of hardware and software, and which can be one or more software systems operating on a general purpose server platform. User profile system 110 receives user risk data and user financial data. The user risk data can include responses to one or more queries that are used to rank the user along a relative risk spectrum. The user financial data can include data regarding the user's current financial net worth, earnings, credit rating, experience with options trading, previous options recommendation data or other suitable data. User profile system 110 can generate risk aversion data from the user risk data. In one exemplary embodiment, the risk aversion data can be a relative risk ranking, such as a value from 1 to 5 where “1” indicates the least risk aversion, and “5” represents the most risk aversion. User profile system 110 provides the risk aversion data, the user financial data, and the option selection data to strategy system 112, and can receive the options recommendation data from strategy system 112. User profile system 110 can then store the options recommendation data as a subset of the user profile data for tracking purposes and progress reporting.

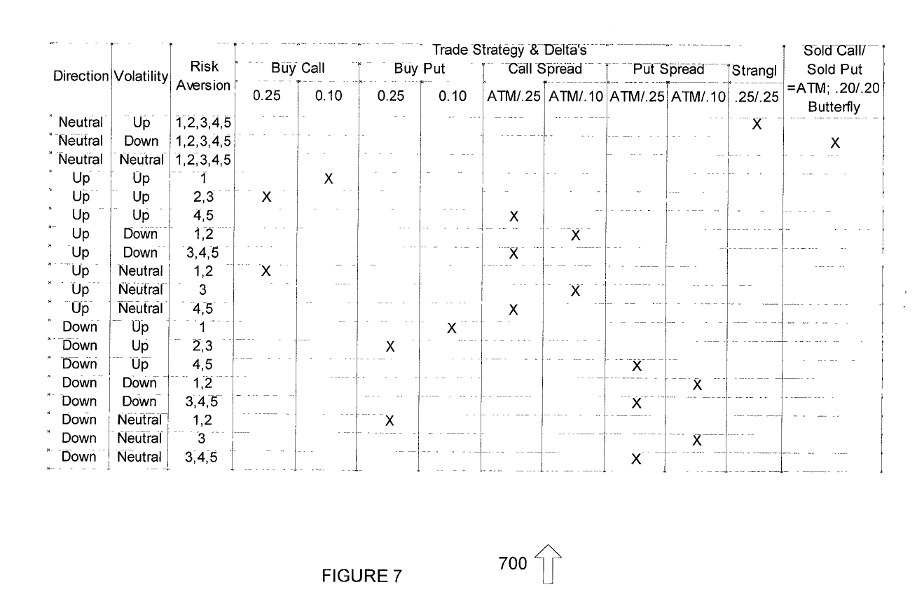

Strategy system 112 receives the risk aversion data and the option selection data from client 106 and the options availability data from options data system 114 and generates options recommendation data. In one exemplary embodiment, strategy system 112 can generate strategy data by applying the option selection data and the user's risk aversion data received from user profile system 110 to a predetermined trading strategy matrix, such as those shown in FIG. 6 and FIG. 7. Strategy system 112 can then use the strategy data to screen options market data from options availability system 104 to generate options recommendation data. In this exemplary embodiment, the options recommendation data includes those theoretical options trades which would be of interest to the user, based on the user's risk aversion, if they are being traded, time frame for the option (such as the date on which the option contract will expire), the user's estimated price direction of the security or index (such as “increase” or “decrease”), the user's estimated volatility for the stock or index (such as “stable” or “volatile”), and the amount of the investment that the user wishes to place at risk (such as “initial amount” and “maximum allowable loss”).

Options data system 114 can be implemented in hardware, software, or a suitable combination of hardware and software, and can be one or more software systems operating on a general purpose server platform. In one exemplary embodiment, options data system 114 can be implemented with the MATLAB software system available from The MathWorks, Inc., of Natick, Mass. Options data system 114 can calculate options pricing data using the Black-Scholes options pricing models, and estimate values required for that model. Options data system 114 can also generate Black-Scholes pricing formulas for index situations, binomial tree or American approximation pricing formulas for stock with dividend situations, Black-Scholes pricing formulas for stock with no dividend situations, European Black-Scholes formulas for stock with low dividends (less than 2%), Black-Scholes pricing formulas for graphical display, and other suitable data. Options data system 114 can generate the dividend percentage, the implied volatility, the strike price, the delta, determine whether there is a sufficient volume for the selected options data sets received from options availability system 104, and provide other suitable functions. In this manner, options data system 114 can be used to determine whether the user has sufficient capital to purchase the options contract. In another exemplary embodiment, options data system 114 can transfer options data selected by the user to user profile system 110 for tracking purposes. In another exemplary embodiment, options data system 114 can receive data from the Chicago Board of Trade or other suitable options trading authorities or organizations.

Neural network system 116 can provide price direction and volatility predictions for securities and indexes, based on historical stock or index data, market conditions, economic indicators, and other suitable data inputs. In one exemplary embodiment, neural network system 116 can receive index closing price data, closing volatility index (VIX) data from the Chicago Board Option Exchange, Money Supply data and Monetary Base data from the Board of Governors of the Federal Reserve System, and other suitable data. Based on this information, neural network system 116 generates price direction data and volatility prediction data for securities and indexes. Neural network system 116 can store the price direction data and volatility prediction data for subsequent access by a user.

In one exemplary embodiment, neural network system 116 can store the following data fields for use in options selection: date and time of prediction, index (such as the S&P 500 and S&P 100 indexes), stock symbol, time period (such as the estimated volatility or price direction in one week, one month, or other suitable time periods), price direction (up, down, neutral), volatility (up, down, neutral) and other suitable data fields. In this exemplary embodiment, neural network system 116 provides the prediction data based upon the security index selected by the user, and translates the prediction data into option selection data to be used by strategy system 112 to generate strategy data.

Client 106 can be implemented in hardware, software, or a suitable combination of hardware and software, and can be one or more software systems operating on a general purpose processing platform. In one exemplary embodiment, client 106 can be a wireless device, such as a personal digital assistant (PDA), a wireless application protocol cell phone, or other suitable wireless devices than enable a user to access option selection system 102 over a wireless network. Client 106 allows a user to provide user profile data, including risk aversion data, and option selection data, and to receive the options recommendation data from option selection system 102. For example, client 106 can allow a user to first set up a user account through option selection system 102. The user can provide user profile data to user profile system 110 at this time, including answering risk questions, providing information regarding the user's income, liquid net worth, earning potential, experience with options trading, and other suitable data. After the account is set up, client 106 can then provide stock ticker symbols, index identifiers, or other suitable securities identification data, and can then receive strategy data and options recommendation data from option selection system 102. Client 106 can also allow a user to place a trade based on the options recommendation data.

Options availability system 104 can be implemented in hardware, software, or a suitable combination of hardware and software, and can be one or more software systems operating on a general purpose processing platform. In one exemplary embodiment, options availability system 104 can be an account, a folder, a database or other suitable system on a server of the Chicago Board of Trade or other suitable options trading authorities or organizations from which options market data can be retrieved by option selection system 102. In another exemplary embodiment, options availability system 104 can receive data from the Chicago Board of Trade or other suitable options trading authorities or organizations. Options availability system 104 provides the options market data to option selection system 102 over communications medium 108. Option selection system 102 can then screen the options market data from options availability system 104, so as to generate options recommendation data.

In operation, system 100 allows a user with limited experience in options trading to receive appropriate options trades based upon the user's trading objectives and aversion to risk. System 100 allows the user to set up an account and to provide data that can be used to determine the user's aversion to risk, to identify the user's trading objectives, and other suitable user data. System 100 then receives options pricing data and options availability data, and recommends options trades to the user based upon whether such options trades fit within the user's trading strategy, risk profile, and whether or not such options are available. System 100 thus allows users to use options trading to achieve investment goals where such users may have been unwilling to do so because of lack of experience in trading options.

FIG. 2 is a diagram of a system 200 for providing user profile data in accordance with an exemplary embodiment of the present invention. System 200 includes user profile system 110 and query test system 202 and stats system 204, each of which can be implemented in hardware, software, or a suitable combination of hardware and software, and which can be one or more software systems operating on a general purpose processing platform.

Query test system 202 generates query data for transmission to a user and receives query responses from the user. Query test system 202 can also generate user profile data from the query response data. In one exemplary embodiment, query test system 202 generates risk aversion data, such as a relative risk ranking value from 1 to 5 or other suitable risk ranking data, which is used by strategy system 112 of FIG. 1 to generate options strategy data. Query test system 202 stores the risk aversion data in a user profile data file in stats system 204 or other suitable systems. The user can also access query test system 202 to update risk aversion data, and query test system 202 can also prompt the user with additional query data at predetermined intervals, in response to an increase or decrease in account value, or at other suitable times.

Stats system 204 stores user profile data and provides the user profile data to strategy system 112 of FIG. 1 to generate options strategy data. User profile data can include income data, available capital data, data defining experience with option trades (such as number of trades, value of trades, number of years of trading), experience with security trading (such as number of trades, value of trades, number of years of trading), and other suitable data. In one exemplary embodiment, stats system 204 can receive updated user profile data from the strategy system 112 or other suitable systems, such as incrementing the number of option or security trades, the length of time that the user has been trading options or securities, the value of option or security trades, account value, or other suitable data. In another exemplary embodiment, stats system 204 can allow a user to update this data, can periodically prompt the user to update the data, or can perform other suitable functions.

In operation, system 200 generates the user's risk aversion data and maintains other user statistics for use in determining the level of experience and risk aversion of a user. System 200 generates objective data that can be used to select one or more option recommendations for a security or index provided by a user, so as to provide the user with assistance in selecting option trades.

FIG. 3 is a diagram of a system 300 for generating options strategy data and options recommendation data in accordance with an exemplary embodiment of the present invention. System 300 includes strategy system 112 and pure options system 302, hedging system 304, and display and reporting system 306, each of which can be implemented in hardware, software, or a suitable combination of hardware and software, and which can be one or more software systems operating on a general purpose server platform.

Pure options system 302 allows a user to generate pure options strategy data based on option selection data and user profile data. Pure options system 302 receives price direction data, volatility data for a security or index, and user risk aversion data, and generates strategy data. In one exemplary embodiment, pure options system 302 generates pure options strategy data for a particular stock symbol where the investor does not already own the underlying security. Pure options system 302 presents one or more queries to the user of one or more of a group comprised of stock symbol, time frame, price direction, volatility, and investment. Pure options system 302 then translates the responses to these queries into option selection data. Pure options system 302 applies this data in conjunction with the risk aversion data to a pure options trading strategy matrix, such as that shown in FIG. 7.

Hedging system 304 generates hedging strategy data for a security or index when the user owns the underlying security or index, is considering purchasing the underlying security or index, or in other suitable situations. Hedging system 304 provides options recommendation data for covered calls, covered puts, or other suitable option trades in which the user owns the underlying security or index that the option is being written on. In one exemplary embodiment, a covered call trading strategy matrix, such as that shown in FIG. 6, can be used by hedging system 304 to generate strategy data, which is subsequently used to generate options recommendation data.

Pure options system 302 and hedging system 304 are both coupled to display and reporting system 306, which generates graphic options recommendation data. In one exemplary embodiment, display and reporting system 306 presents the options recommendation data, a trade analysis of the options recommendation data, a graphical analysis of the options recommendation data, and a financial analysis of the options recommendation data. In another exemplary embodiment, display and reporting system 306 can be used to save or update the user profile data with options recommendation data presented to the user for future tracking purposes.

In operation, system 300 allows users with limited experience in options trading to receive trading strategies, based upon the user's experience and aversion to risk, and options trades selected on the basis of those trading strategies. System 300 can provide a user with pure option strategy data, hedging strategy data, or other suitable data for a security or index, where the user either currently owns the security or index, or intends to purchase it before writing the call, put or other suitable option.

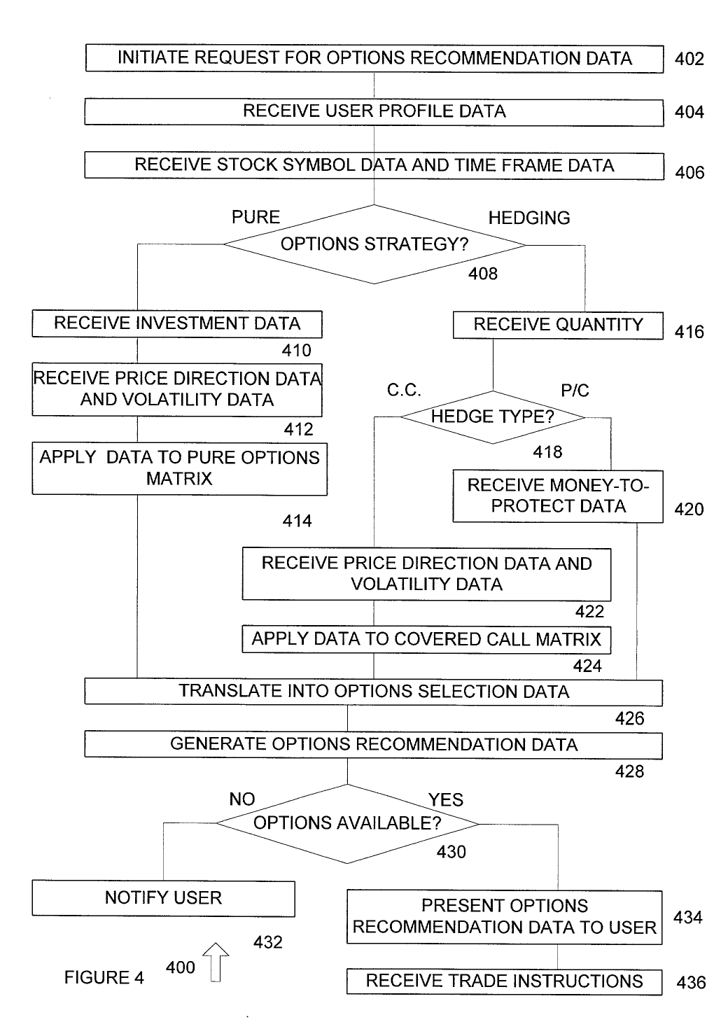

FIG. 4 is a flowchart of a method 400 for providing options recommendation data to a user in accordance with an exemplary embodiment of the present invention. Method 400 begins at 402 where a user initiates a request for options recommendation data. In one exemplary embodiment, the request for options recommendation data can be initiated when the user provides a symbol or other suitable data that identifies a security or index. The method then proceeds to 404 where the user profile data is received. In one exemplary embodiment, risk aversion data, trading experience data, and other user profile data is received from user profile system 110 when the user logs on or otherwise indicates that they would like to receive options recommendation data. The method then proceeds to 406.

At 406, stock symbol data, time frame data (such as the date on which the option will expire), and other suitable information identifying a security or index are received. In one exemplary embodiment, the stock symbol data can be input by the operator of client 106 at 402, and the user can be presented with time frame data for selection at 406. The method then proceeds to 408.

At 408, it is determined whether the user is seeking pure options strategy data or hedging strategy data. The user can also be presented with data that explains the difference between these strategies, such that if the user is unfamiliar with the strategies then an example of the application of such strategies to the security of interest to the user can be provided. If the user is seeking pure options strategy data, then the method proceeds to 410 where investment data or other suitable data identifying the amount of the investment that the user wishes to place at risk is received. The method then proceeds to 412, where price direction data and volatility data (such as up, down, or neutral) or other suitable information identifying the estimated price direction and volatility for the stock or index is received. In one exemplary embodiment, the investment data, price direction data, and volatility data can be received from the operator of client 106, from the prediction data received from neural network system 116, or from other suitable sources. The method then proceeds to 414, where stock symbol data, risk aversion data, and other suitable data are used to generate options strategy data that includes one or more generic trading strategy recommendations. In one exemplary embodiment, the risk aversion data can be applied to a pure options strategy matrix such as that shown in FIG. 6 to generate the pure options strategy data that can be used to select one or more trade recommendations. The method then proceeds to 426.

If it is determined at 408 that the user is seeking hedging strategy data, the method proceeds to 416 where quantity data or other suitable data identifying the number of shares of the underlying security owned or being purchased by the user is received. The method then proceeds to 418 where it is determined whether the user is asking for a covered call hedging strategy or a put/collar hedging strategy. The user can also be presented with data that explains the difference between these strategies, such that if the user is unfamiliar with the strategies then an example of the application of such strategies to the security of interest to the user can be provided. If the user is seeking a put/collar hedging strategy, then the method proceeds to 420 where security value data or other suitable information identifying the price of the stock or underlying security to protect is received. The method then proceeds to 426. Otherwise, if it is determined at 418 that the user is seeking a covered call hedging strategy, then the method proceeds to 422.

At 422, price direction data and volatility data (such as up, down, or neutral) or other suitable information identifying the estimated price direction and volatility of the stock or index is received. In one exemplary embodiment, the price direction data and the volatility data can be received from the operator of client 106, from the prediction data received from neural network system 116, or from other suitable sources. The method then proceeds to 424, where the risk aversion data, stock symbol data, and other suitable data are used to generate one or more generic trading strategy recommendations. In one exemplary embodiment, the risk aversion data and stock symbol data are applied to a covered call hedging strategy matrix, such as that shown in FIG. 7, to generate the hedging strategy data. The method then proceeds to 426.

At 426, the stock symbol data, time frame data, and other suitable data is translated into option selection data, such as by obtaining currently traded options from a market data system. The method then proceeds to 428, where the generic trading strategy recommendations generated at 412 or 424 are applied to the option selection data to generate options recommendation data. Generating options recommendation data can also include generating appropriate alternative options recommendation data, such as second-best alternative options recommendation data or other suitable data, based on time frame data, other option selection data or other suitable data. In one exemplary embodiment, if the user is seeking a covered call trading strategy, then covered call options being traded on the market that match the generic trading strategy recommendations are selected as the options recommendation data. The method then proceeds to 430.

At 430, it is determined whether options matching the options recommendation data are being offered for sale or purchase. In one exemplary embodiment, market data can be obtained that shows the number of options being offered for sale, for purchase, options trading volume, bid and offer prices, or other suitable data. This market data can then be compared to the options recommendation data, which may include appropriate alternative options recommendation data, such as second-best alternative options recommendation data or other suitable data. If the market data indicates that options contracts are not available that match the options recommendation data, then the method proceeds to 432 where the user is notified that such options are not currently available. Otherwise, the method proceeds to 434 where the user is presented with one or more sets of options recommendation data. In one exemplary embodiment, the options matching the recommendation data are provided with graphical data showing the quantity of options required to meet the user's objectives, a loss/gain analysis, and other suitable information. The method then proceeds to 436 where the user receives instructions to complete the transaction and purchase the recommended options contract.

In operation, method 400 generates options recommendation data based upon the user's trading objectives, information on the underlying security, and aversion to risk. Method 400 provides a user with recommended trading strategies, based on the user profile data, risk aversion data, option selection data, and other suitable data. Method 400 can receive option selection data from the operator of client 106 or from the prediction data received from neural network system 116.

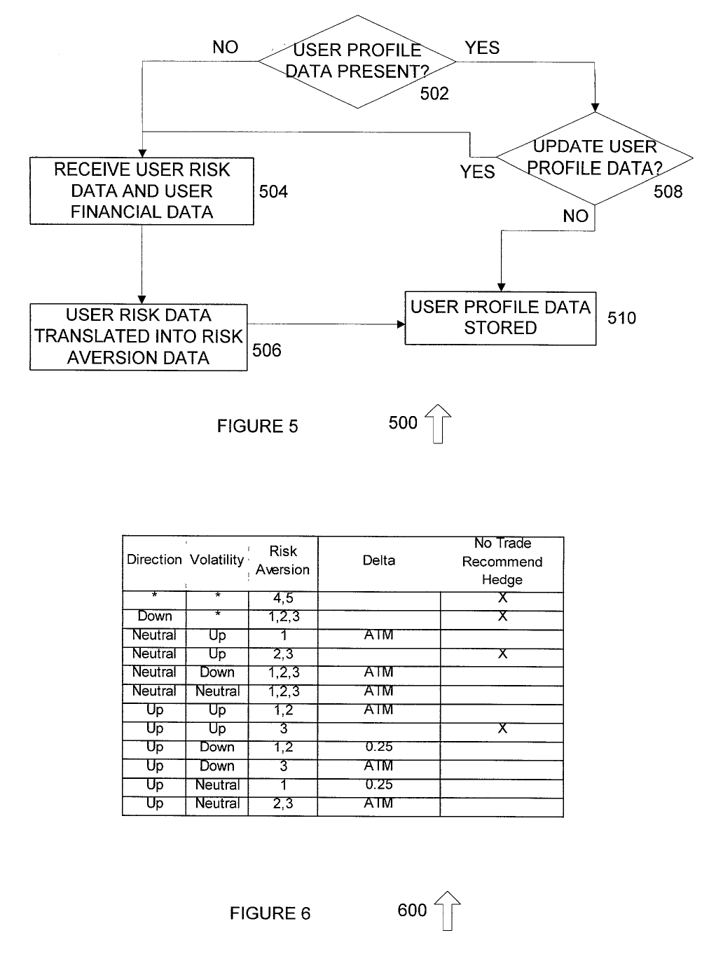

FIG. 5 is a flowchart of a method 500 for receiving user profile data and a user's risk aversion data in accordance with an exemplary embodiment of the present invention. Method 500 begins at 502 where it is determined whether user profile data is present or not. If user profile data exists, the method then proceeds to 508. Otherwise, if no user profile data exists, then the method proceeds to 504.

At 504, the user risk data and user financial data is received. In one exemplary embodiment, the user can be presented with one or more queries, such as where each query has been formulated so that the response can be used to classify the user along a relative scale of risk aversion as compared to other users. After the response data to the queries is received, user risk data can be determined based on the response data. The method then proceeds to 506 where the user risk data is translated into risk aversion data. In one exemplary embodiment, each query can have an associated risk aversion value and a relative weighting factor, such that the risk aversion data can be generated by obtaining a weighted average of the user's risk aversion values as adjusted by the relative weighting. Other suitable procedures can also be used. The method then proceeds to 510.

At 508, the user can update the user profile data. If the user updates the user profile data, then the method proceeds to 504. In one exemplary embodiment, the user can opt to update the user profile data because the user's aversion to risk has changed, because the user has gained more experience with options trades, because the user has had an increase or decrease in the capital he is willing to risk, or because of other suitable changes in user's profile data. Otherwise, the method then proceeds to 510 where the user profile data is stored for subsequent use in selecting options trades.

In operation, method 500 provides user profile data and risk aversion data for use in selecting one or more options trades for a user. Method 500 also allows a user to update the user profile data as the user's aversion to risk or other suitable information within the user profile data changes.

FIG. 6 is a matrix 600 for providing hedging strategy data in accordance with an exemplary embodiment of the present invention. The first column of matrix 600 represents price direction data or other suitable information identifying the estimated price direction of the security or index, such as up, down, neutral or other suitable values. The second column of matrix 600 represents volatility data or other suitable information identifying an estimate of how fast the underlying security or index changes in price, such as up, down, neutral or other suitable values. The third column of matrix 600 represents risk aversion data or other suitable information identifying the user's aversion to risk. In one exemplary embodiment, the risk aversion data can be a relative risk ranking, such as a value from 1 to 5 where “1” indicates the least risk aversion, and “5” represents the most risk aversion.

The fourth column of matrix 600 represents the delta value for a covered call trading strategy or other suitable information indicating the dollar amount by which the price of an option moves for every unit change in the underlying security or index. In one exemplary embodiment, the delta for a covered call trading strategy can be a value of the group consisting of At-The-Market (“ATM”), “0.25”, no value, or other suitable value. The specified delta of a trading strategy is inversely related to the amount of risk associated with an options trade. Therefore, a user with a medium risk aversion can engage in a covered call trading strategy if the delta is ATM or the current stock price, whereas a user with less risk aversion can utilize a covered call with a delta of 0.25. In this exemplary embodiment, if the user provides [neutral; neutral; 3] as the values for the price direction data, the volatility data, and the risk aversion data, then delta has a value of ATM. This indicates to the user that selling a number of call option contracts for the underlying security or index to give him the right to buy shares of the underlying security at the ATM value on expiration of the option contracts would meet the user's investment goals and risk criteria. Thus, the investor can protect the value of the underlying security or index against a drop in price, yet obtain a predetermined return on the user's investment if the price of the stock increases.

The last column of matrix 600 represents “No Trade, Recommend Hedge” or other suitable information indicating that a covered call trade is not recommended, but a different hedging strategy is. In one exemplary embodiment, this data can be a toggle value, such as a value consisting of an “X” or no value or other suitable method of selection.

The risk aversion data, the price direction data, the volatility data, and other suitable data are applied to matrix 600 to generate hedging strategy data. In one exemplary embodiment, the price direction data, the volatility data, and the risk aversion data can be applied to matrix 600 to isolate one row with corresponding values for price direction, volatility, and risk aversion. In this row, if delta has a value of “ATM” or “0.25”, then a covered call trading strategy with its associated delta can be translated into the strategy data. If delta has no value and the last column has a value of “X”, then no covered call trade is recommended, and a buy put trading strategy and a collar strategy can be translated into the strategy data.

In operation, matrix 600 provides the hedging strategy data to be used to generate options recommendation data. Matrix 600 indicates whether a covered call trading strategy or a different hedging strategy should be recommended to the user, based on the direction of the price of the underlying security, the volatility of the price of the underlying security, the user's aversion to risk, and other suitable data.

FIG. 7 is a matrix 700 for providing pure options strategy data in accordance with an exemplary embodiment of the present invention. The first column of matrix 700 represents price direction data or other suitable information identifying the estimated price direction of the security or index, such up, down, neutral or other suitable values. The second column of matrix 700 represents volatility data or other suitable information identifying the estimated volatility for the stock or index, such as up, down, neutral, or other suitable values. The third column of matrix 700 represents risk aversion data or other suitable information identifying the user's aversion to risk. In one exemplary embodiment, the risk aversion data can be a relative risk ranking, such as a value from 1 to 5 where “1” indicates the least risk aversion, and “5” represents the most risk aversion.

The next columns represent strategy data or other suitable information identifying the possible trading strategies that can be generated with a specified delta or other suitable information indicating the dollar amount by which the price of an option moves for every unit change in the underlying security or index. For example, the specified delta of a trading strategy is inversely related to the amount of risk associated with an options trade. Therefore, if the strategy data is a buy call with a delta of 0.25, then the present invention should find an options contract with a specified delta of 0.25 since it is less risky than purchasing a buy call option contract with a specified delta of 0.10. In one exemplary embodiment, the column representing strategy data can be selected for each combination of values for the risk aversion data, the price direction data, and the volatility data by having a toggle value, such as a value consisting of an “X” or no value, or other suitable method of selection.

The risk aversion data, the price direction data, the volatility data, and other suitable data for a user are applied to matrix 700 and option selection data to generate pure options strategy data. In one exemplary embodiment, the price direction data, the volatility data, and the risk aversion data can be applied to matrix 700 to isolate one row with corresponding values for price direction, volatility, and risk aversion. The column with an “X” in this row is the strategy data. For example, if the user provides down, neutral, and 3 as the values for the price direction data, the volatility data, and the risk aversion data, then the trading strategy with a value of “X” is a put spread with a delta of At-The-Market (ATM) and 0.10. Here, the present will search for a buy put option contract with a strike price equivalent to the ATM or current stock price and for a sell put option contract with a lower strike price. In this manner, an investor has a significant downside profit potential as well.

In operation, matrix 700 provides the pure options strategy data to be used to generate options recommendation data. Matrix 700 selects the strategy data based on the direction of the price of the underlying security, the volatility of the price of the underlying security, the user's aversion to risk, and other suitable data.

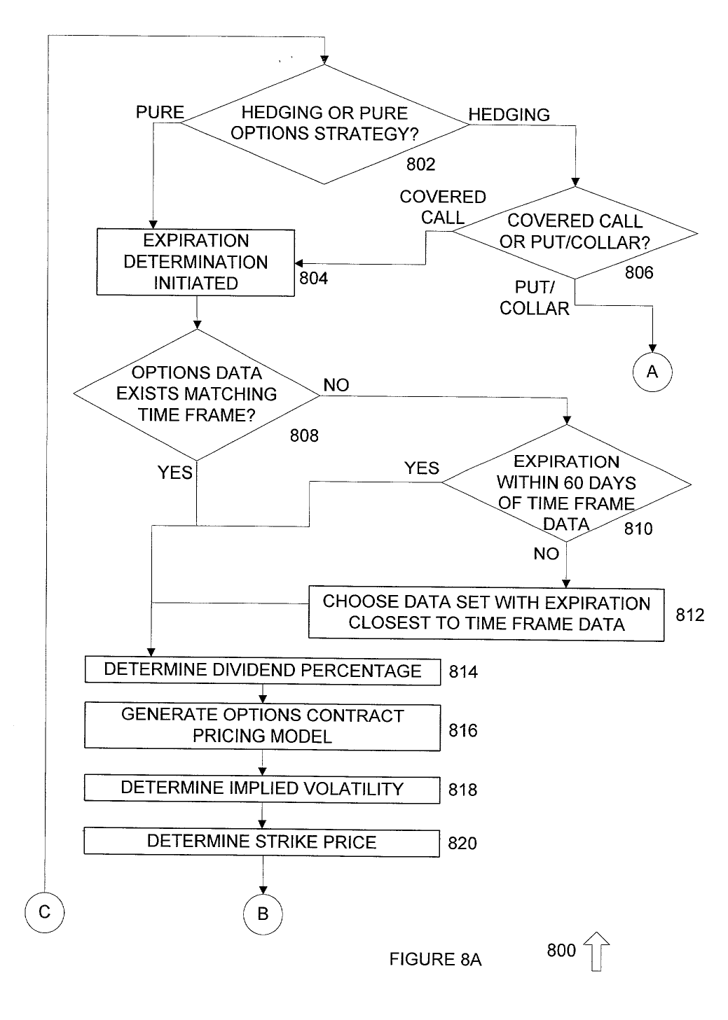

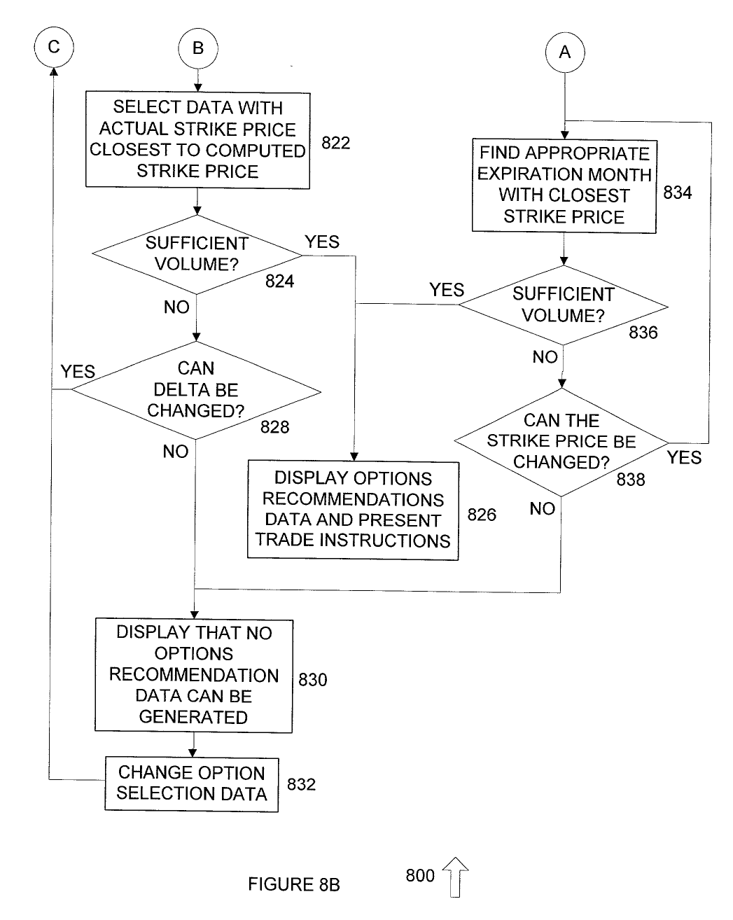

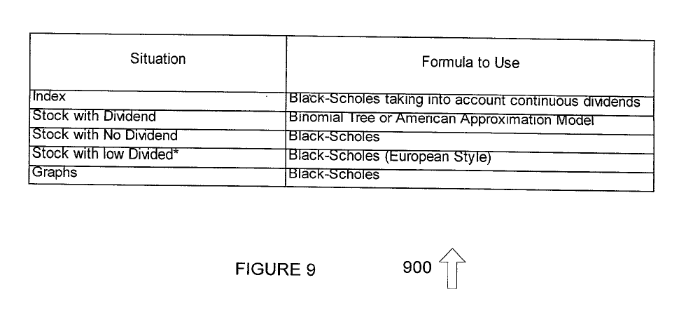

FIGS. 8A-8B are flowcharts of a method 800 for providing options recommendation data in accordance with an exemplary embodiment of the present invention. Method 800 begins at 802 where it is determined whether hedging strategy data or pure options strategy data was generated. If pure options strategy data was generated, then the method proceeds to 804. Otherwise, if hedging strategy data was generated, then the method proceeds to 806 where it is determined whether a covered call trading strategy data or put/collar trading strategy was generated as strategy data. If a covered call trading strategy was generated, then the method proceeds to 804. Otherwise, if a put/collar trading strategy was generated, then the method proceeds to 834.

At 804, the expiration month is determined, such as by generating a user prompt that requests entry of time frame data, generation of a user-selectable display that includes available time frame data, or other suitable procedures. The method then proceeds to 808 where it is determined whether options data exists with an expiration matching the user's time frame data. If so, then the method proceeds to 814. Otherwise, the method then proceeds to 810 where it is determined whether options data exists with an expiration date within a predetermined time period, such as 60 days, after the user's time frame data. If so, then the method proceeds to 814. Otherwise, the method then proceeds to 812 where the options data with an expiration closest to the user's time frame data is selected. The method then proceeds to 814.

At 814, the dividend percentage of the options data from 808, 810, or 812 is determined. The method then proceeds to 816 where the options contract pricing model data is generated based on a pricing model matrix. The pricing model matrix can include columns representing situation data and one or more mathematical formulae used to calculate the price of the options contract. The situation data can be applied to this matrix to select the formula that is to be used to select the options trade contract. For example, a Black-Scholes pricing model can be used for a stock with no dividends; a Black-Scholes (European Style) pricing model can be used for a stock with a low dividend (less than 2%); a Binomial Tree or American Approximation pricing model can be used for an index option, or other suitable formulae can be used. The method then proceeds to 818.

At 818, the implied volatility is determined. In one exemplary embodiment, the price of the selected options data can be determined as a function of market stock price, dividend/ex-dividend date, real interest rate, time to maturity, volatility, and strike price. The implied volatility can then be calculated through an iterative process using the MATLAB software system available from The MathWorks, Inc., of Natick, Massachusetts. The method then proceeds to 820.

At 820, the strike price is calculated. In one exemplary embodiment, the appropriate strike price to buy/sell can be determined by solving for delta using an iterative procedure, where delta is a function of market stock price, dividend/ex-dividend date, time to maturity, real interest rate, implied volatility, and strike price. The MATLAB software system can also be used in this exemplary embodiment. The method then proceeds to 822 where a data set with an actual strike price closest to the computed strike price is selected from the options data sets provided by 808, 810, or 812. The method then proceeds to 824.

At 824, it is determined whether there is sufficient volume for the selected options data set. If so, then the method proceeds to 826 where the selected options data set is translated to options recommendation data and presented to the user in graphical format. The user can also be presented with trade options to allow the user to buy or sell an option based on the recommendation. Otherwise, if it is determined at 824 that sufficient volume does not exist, then the method proceeds to 828.

At 828, it is determined whether the delta value for the strategy data can be changed. If so, then the method proceeds to 802. In one exemplary embodiment, if the strategy data generated had a delta value of 0.10, then the same strategy data with a delta of 0.25 can be used. Otherwise, if the delta value for the strategy data cannot be changed, then the method proceeds to 830 where the user is notified that no options data sets exist based on the strategy data and the option selection data. The method then proceeds to 832 where the user can change the time frame data or other suitable option selection data. If the user changes the option selection data, then the method proceeds to 802.

At 834, options data sets with an expiration and strike price corresponding to the user's option selection data are selected from available options that are being traded. The method then proceeds to 836 where it is determined whether sufficient volume exists to purchase the options trade represented by the selected options data set. If so, then the method proceeds to 826 where the selected options data set is translated to options recommendation data and presented to the user. Otherwise, if there is insufficient volume, then the method proceeds to 838 where it is determined whether the strike price can be changed and remain with the same trading strategy. If the strike price can be changed, then the method proceeds to 834. Otherwise, the method then proceeds to 830.

In operation, method 800 provides options recommendation data based on suitable data, such as the strategy data generated by trading strategy matrices (such as those shown in FIG. 6 and FIG. 7), the option selection data from method 800, the risk aversion data from method 500, or other suitable data. Method 800 can also be used to notify a user that options recommendation data is not available based on the strategy data, the option selection data, and other suitable information.

Although exemplary embodiments of a system and method for providing options recommendation data have been described in detail herein, those skilled in the art will also recognize that various substitutions and modifications can be made to the systems and methods without departing from the scope and spirit of the appended claims.

What is claimed is:

1. A system for providing options trading data comprising:
an options data system storing options data;
a user profile system storing user profile data; and
an options selection system coupled to the user profile system and the options data system, the options selection system generating options trading data.

2. The system of claim 1 wherein the options data system further comprises an options pricing system providing options pricing data based on options strategy data generated.

3. The system of claim 1 wherein the options data system further comprises an options availability system coupled to the options pricing system, the options availability system providing option availability data based on options pricing data.

4. The system of claim 1 wherein the user profile system further comprises a query test system generating one or more queries to the options client, receiving user response data in response to the one or more queries from the options client, and generating a risk ranking.

5. The system of claim 1 wherein the user profile system further comprises a stats system storing statistics making up user profile such as the risk ranking, income, previous trades, previous trades using the system of claim 1.

6. The system of claim 1 wherein the options selection system further comprises a strategy system coupled to the user profile system, the strategy system generating options strategy data based on the user profile data and the options data.

7. The system of claim 6 wherein the strategy system further comprises a pure options system generating pure options strategy data based on the user profile data and the options data.

8. The system of claim 6 wherein the strategy system further comprises a hedging system generating hedging strategy data based on the user profile data and the options data.

9. The system of claim 1 wherein the options selection system further comprises a neural options system coupled to the strategy system and the user profile system, the neural options system having recommended options data, generating one or more queries to the user based on recommended options data and user profile data, receiving response data from the user, and sending recommended options data to the strategy system.

10. A method for providing options trading data comprising:
receiving user profile data;
receiving option selection data; and
generating options trading data based on the user profile data and the option selection data.

11. The method of claim 10 wherein receiving the user profile data further comprises:
presenting one or more queries to a user;
receiving response data from the user; and
determining risk aversion data from the query data and the response data.

12. The method of claim 10 wherein receiving option selection data comprises receiving one or more of the group consisting of stock name, quantity, time frame, price direction, volatility, investment, and dollar amount to protect.

13. The method of claim 10 wherein generating options trading data based on the user profile and the option selection data further comprises:
determining if pure options strategy data is required; and
determining if hedging strategy data is required.

14. The method of claim 13 wherein determining if hedging options strategy data is required further comprises:
presenting one or more queries to a user;
receiving response data from the user; and
determining if covered call trading data is required; and
determining if put-collar trading data is required.

15. The method of claim 14 wherein determining if covered call trading data is required further comprises:
applying risk aversion data and option selection data to a predetermined a covered call strategy matrix; and
saving strategy data received from matrix.

16. The method of claim 10 further comprises finding available option contracts based on the options trading data generated.

17. The method of claim 16 wherein finding available option trades based on the options trading data generated comprises:
finding an option trade with the appropriate expiration month;
computing the dividend percentage;
determining a price per a decision matrix;
determining an implied volatility;
determining a strike price;
finding an option trade closest to the strike price;
determining if sufficient volume exists for the selected option trade; and
presenting graphic selected option trade data.

18. The method of claim 17 wherein presenting graphic selected option trade data comprises:
displaying that no option trade data is available to the user if none can be found based on the option selection data and
displaying option trade data if one or more can be found based on the option selection data.

19. The method of claim 18 wherein displaying that no option trade data is available to the user if none can be found based on the option selection data further comprises:
presenting one or more queries to the user;
receiving response data from the user;
changing the option selection data based on the response data from the user; and
finding another option trade based on the new option selection data.

20. A method for providing recommended options trading data comprising:
receiving stock symbol data;
generating prediction data for stock symbol data; and
receiving other option selection data;
receiving user profile data; and
generating options trading data based on the user profile data and the option selection data.

21. The method of claim 20 wherein generating prediction data for stock symbol data comprises:
generating predicted price direction data for predetermined time frames for stock symbol data and
generating predicted volatility data for predetermined time frames for stock symbol data.

22. The method of claim 20 wherein generating option selection data comprises:
generating prediction data on the basis of predicted price direction data;
generating volatility data on the basis of predicted volatility data; and
receiving other subsets of option selection data.
